(19) United States
(12) Patent Application Publication
(10) Pub. No.: US 2024/0246104 A1
(43) Pub. Date: Jul. 25, 2024

(54) PROVIDING A COATING LAYER FOR A LABEL WEB

(71) Applicant: UPM Raflatac Oy, TAMPERE (FI)

(72) Inventors: Markus PÄÄKKÖNEN, Tampere (FI); Janne VALKAMA, Valkeakoski (FI)

(21) Appl. No.: 18/289,235

(22) PCT Filed: May 28, 2021
(86) PCT No.: PCT/FI2021/050390

§ 371 Date: Nov. 2, 2023

(51) Int. Cl. B05C 1/08; B31D 1/02

(52) U.S. Cl. CPC B05C 1/0856; B05C 1/0813; B05C 1/0817; B31D 1/021; B31D 2201/02

(57) ABSTRACT

The invention relates to a method for providing a coating lay for a label web (100), the method comprising arranging a substrate, applying a metered coating (121) in a contactless manner onto a surface of a coating roll (510), and transferring the coating (121) from the coating roll (510) onto the substrate (140) in a nip (515) thereby forming a coating layer onto the substrate, wherein, in the nip (515), the surface of the coating roll (510) is running in an opposite direction to a movement of the substrate (140), thereby obtaining the coating layer for a label web. The invention further relates to a system for providing a coating lay for a label web (100). The invention further relates to method for manufacturing a label web.

### TECHNICAL FIELD

This specification relates to a method and an arrangement for providing a coating layer for a label web. This specification further relates to a method for manufacturing a label web.

### BACKGROUND

In industry, a large variety of labels is manufactured for a large variety of different end uses. A conventional label structure, often called a label laminate, comprises a printable face material and release layer coated backing material (release liner) laminated together with a pressure sensitive adhesive. Such label laminate web can then be converted into individual adhesive labels which are carried further on the release liner. From the release liner the individual labels can be dispensed onto items to be labelled. Alternatively, a more ecofriendly label web may be formed without a liner. Such linerless label webs may consist of a printable face material top-coated with release layer and arranged with pressure sensitive adhesive on the opposing bottom surface. The face material may preprinted or thermally printable. The linerless label web may be self-wound onto a roll. In case of thermally printable variable information applications the labels are printed and cut into individual labels per need upon dispensing.

However, manufacturing of both linered and linerless label materials are known to have certain challenges. Particularly, coating of different type of coatings accurately onto different type of web materials with varying web processing speeds and predetermined adhesive patterning presents significant manufacturing challenges. All these parameters may be selected differently depending on the label end use in question. Still, for sake of economical manufacturing, same manufacturing equipment should be suitable or easily adjustable for manufacturing of different type of label materials also using shorter production runs.

Thus, there is still need for an improved label product, and an improved method for manufacturing label products providing increased flexibility to answer the requirements of different label end uses. A successful production of labels requires successful and speedy production of machine rolls.

### SUMMARY

It is an aim of this specification to provide a method for providing a coating layer for a label web. Further, it is an aim of this specification to provide an arrangement for providing a coating layer for a label web. Further, it is an aim of the specification to provide a method for manufacturing a label web.

Aspects of the invention are characterized by what is stated in the independent claims. Preferred embodiments are disclosed in the dependent claims. These and other embodiments are disclosed in the description and figures.

The label web may be a linerless label web, or the label web may be a label laminate comprising a release liner. The label web may comprise at least a face and a pressure sensitive adhesive coating. The face can have a first side and a second side. The first side of the face can be the top side of the face, and the second side of the face can be the bottom side of the face.

The second side of the face can comprise a pressure sensitive adhesive coating. If the label web is a label laminate comprising a release liner, the pressure sensitive adhesive coating may be left in between the face and the release liner.

The first side of the face may have a printable surface. In an embodiment, the first side of the face comprises a direct thermal printable coating.

In an embodiment, the first side of the face comprises a release coating. This embodiment is particularly advantageous for linerless label webs.

The arrangement for providing a coating layer for a label web may comprise a coating unit and a coating roll. The coating unit may comprise an applicator, which feeds a coating in a contactless manner onto a surface of the coating roll.

The coating can be metered before it is applied onto the coating roll. This kind of coating method using contactless coating method wherein a pre-metered coating is applied on to the coating roll may improve evenness of the coating layer, even with a substantially thin coating layer. Further, the method may be usable with many kinds of aqueous solutions, e.g. adhesives and coatings having, e.g., substantially low viscosity.

A method for providing a coating layer for a label web may comprise:
applying a metered coating in a contactless manner onto a surface of a coating roll, and
transferring the coating from the coating roll onto a substrate in a nip thereby forming a coating layer onto the substrate, wherein, in the nip, the surface of the coating roll is running in an opposite direction to a movement of the substrate,
and
forming a label web comprising a face and the coating.

The metered layer may be continuous or substantially continuous layer, or the metered layer may be non-continuous layer.

Said non-continuous layer may be provided, e.g. by using a slot die coating for applying the metered coating, or at least part of the coating. The non-continuous layer may comprise, e.g. stripes in a cross direction of the coating roll. In this embodiment, the non-continuous areas of the layer may be advantageous, e.g., for removing some adhesive from rolls of a label printer during end use of the label web.

The continuous layer may be provided, e.g., by using curtain coating and/or slot die coating for applying the metered coating layer.

The coating may be applied onto the coating roll by using a curtain coating. Thus, at least part of the coating may be applied onto the coating roll by using a curtain coating. In an embodiment, only one coating layer is applied by using the curtain coating. In another embodiment, more than one coating layer is applied by using curtain coating. In this embodiment, the curtain coating is preferably implemented with a slide coating.

At least part of the coating may be applied on a first location of the coating roll by using the curtain coating, and the first location may be selected so that a first angle α

that is measured in a travel direction of the coating roll between
a vertical line formed from a center of the coating roll to an uppermost point of the surface of the coating roll, and
a first line formed from the center of the coating roll to a first point of a coating roll, the first point defining a point wherein the curtain coating applies the coating onto the coating roll,
   is approximately 0°, for example in a range between 0° and 10°.

Alternatively, the coating may be applied on to the coating roll by using a slot die coating. Thus, at least part of the coating may be applied onto the coating roll by using a slot die coating. In an embodiment, only one coating layer is applied by using the slot die coating. In another embodiment, more than one coating layer is applied by using multi slot die coating.

At least part of the coating may be applied on a second location of the coating roll by using the slot die coating, and the second location may be selected so that a second angle β

that is measured in a travel direction of the coating roll between
a vertical line formed from a center of the coating roll to an uppermost point of the surface of the coating roll, and
a second line formed from the center of the coating roll to a second point of the coating roll, the second point defining a point wherein the slot die coating applies the coating onto the coating roll,
   is in a range between 90° and 270°, preferably in a range between 90° and 180°

Further, another type of premetering, non-contact coating methods or combinations of such may be applicable.

The method may further comprise:
removing part, preferably from 10 to 90 wt.-%, of the coating from the coating roll in order to form non-coated areas on the coating roll before transferring the coating onto the substrate.

In this embodiment, the coated areas are preferably forming coating stripes.

In this embodiment, a location wherein part of the coating is removed may be selected so that a third angle λ
that is measured in a travel direction of the coating roll between
a vertical line formed from a center of a coating roll to an uppermost point of the surface of the coating roll, and
a third line formed from the center of the coating roll to a third point of a coating roll, the third point defining a point wherein part of a coating is removed from a surface of the coating roll,
is in a range between 190° and 270°.

The areas wherefrom the coating is removed can form non-coated areas. Amount of the coating on the non-coated areas may be approximately 0 g/m².

Said part of the coating may be removed from the coating roll by using a blade. The blade may be arranged to remove part of the coating from the coating roll in order to form e.g. coating stripes onto the coating roll. The blade may be a stationary patterned blade. Thus, it is possible to obtain continuous or non-continuous coating stripes. The blade may be made of polyethylene terephthalate (PET).

A location of the nip between the coating roll and the reverse roll may be selected so that a fourth angle δ
that is measured in a travel direction of the coating roll between
vertical line formed from center of the coating roll to uppermost point of the surface of the coating roll, and
a fourth line formed from the center of the coating roll to a fourth point of the coating roll, the fourth point defining a point wherein the coating is transferred from the coating roll onto a substrate in the nip,
   is in a range between 270° and 350°.

A length of the nip, determined in a travel direction of the coating roll, is preferably in a range between 3 mm and 7 mm. Further, a pressure of the nip may be in a range between 500 N/m and 1000 N/m.

In order to improve the production efficiency of the label web, the coating is preferably an adhesive coating. However, also other kinds of label web coatings may be use.

The substrate is preferably the face. Alternatively, the substrate is the release liner. Alternatively, the substrate is a carrier material, and the method further comprises: transferring the coating from the carrier material onto the face or onto a release liner.

A label web may be obtainable by any method disclosed in this specification.

An arrangement for providing a coating layer for a label web may comprise:
a coating roll arranged to have a travel direction,
a coating unit arranged to apply a metered coating in a contactless manner onto the coating roll,
a reverse roll arranged to form a nip between the coating roll and the reverse roll, wherein the coating is arranged to be transferred from the coating roll onto a substrate in the nip, wherein the coating roll is arranged, in the nip, to run in the opposite direction to movement of the reverse roll.

The coating unit or units to be used may be selected, for example, based on a viscosity of the coating, a thickness of the formed coating layer, and/or a speed of the substrate.

A first location of the coating unit can be determined so that the first location has a first angle α in a range between 0° and 10°, which first angle is measured in the travel direction of the coating roll between
a vertical line formed from a center of the coating roll to an uppermost point of the surface of the coating roll, and
a first line formed from the center of the coating roll to a first point of the coating roll, the first point defining a point wherein at least part of the coating is applied onto the coating roll.

The coating unit may comprise a curtain coating unit. The curtain coating unit may be arranged to apply only one coating layer on the surface of the coating roll. The curtain coating unit may be a slide coating unit which is arranged to apply more than one coating layer on the surface of the coating roll. The curtain coating unit may be arranged to apply the coating at the first location.

A second location of the coating unit may be determined so that the second location has a second angle β in a range between 90° and 270°, preferably in a range between 90° and 180°, which second angle β is measured in the travel direction of the coating roll between
a vertical line formed from a/the center of the coating roll to uppermost point of the surface of the coating roll, and
a second line formed from the center of the coating roll to a second point of the coating roll, the second point defining a point wherein at least part of the coating is applied onto the coating roll.

The coating unit may comprise a slot die coating unit. The slot die coating unit may be arranged to apply the coating at the second location.

The coating unit may comprise both, the curtain coating unit and the slot die coating unit. In this embodiment, the curtain coating unit may be arranged to apply the coating at the first location and the slot die coating unit may be arranged to apply the coating at the second location.

A coating removal unit may be arranged to remove part, such as from 10 to 90 wt.-%, of the coating from the coating roll in order to form non-coated areas on the coating roll. Thus, it is possible, e.g., to form stripes or other patterns on the coating roll before transferring the patterned coating onto the substrate.

A location of the coating removal unit is determined so that the location has a third angle λ in a range between 190° and 270°, which third angle is measured in the travel direction of the coating roll between
the vertical line formed from the center of the coating roll to uppermost point of the surface of the coating roll, and
a third line formed from the center of the coating roll to a third point of a coating roll, the third point defining a point wherein part of the coating is removed from the coating roll.

The coating removal unit can comprise a blade. In an embodiment, part of the coating is removed from the coating roll by using a stationary patterned blade capable of forming adhesive free straight stripes on the coating roll.

In an embodiment, part of the coating is removed from the coating roll by using an oscillating blade capable of forming non-straight or otherwise patterned adhesive areas on the coating roll.

The blade is preferably made of polyethylene terephthalate (PET).

A location of the nip may be determined so that the location has fourth angle δ in a range between 270° and 350°, wherein the fourth angle δ is measured in the travel direction of the coating roll between
the vertical line formed from the center of the coating roll to the uppermost point of the surface of the coating roll, and
a fourth line formed from the center of the coating roll to a fourth point of the coating roll, the fourth point defining a point wherein the coating is arranged to be transferred from the coating roll on to the substrate.

A length of the nip, determined in the travel direction of the coating roll, may be arranged to be in a range between 3 mm and 7 mm. This may be obtained e.g. by using a reverse roll having substantially soft surface. The length of the nip can be controlled, e.g., by selecting a nip pressure so that the predetermined nip length can be obtained. Thanks to said nip length and the opposite directions, the coating may be efficiently transferred from the coating roll onto the substrate. Further, a pressure of the nip may be arranged to be in a range between 500 N/m and 1000 N/m.

The arrangement may further comprise means for forming a label web comprising the coating and a face.

The coating is preferably pressure sensitive adhesive coating.

The substrate is preferably a face, a release liner, or a carrier material. In the case of the carrier material, the coating is preferably transferred from the carrier material on to a face or a release liner.

The coating unit(s) may be contactless coating unit(s). In an embodiment, the arrangement comprises two different kind of coating units, preferably the curtain coating unit and the slot die coating unit, from which only one may be used at any single time for applying coating onto the coating roll.

In an embodiment, the coating is an adhesive coating, part of the adhesive coating is removed from the coating roll so that adhesive stripes are first provided on the coating roll and then transferred from the coating roll onto a substrate.

Thanks to the novel solution, wherein a coating is applied onto a coating roll by using a contactless coating method, several advantages may be obtained. Particularly, easiness and controllability of the manufacturing process of the label web may be improved. For example, it may be possible to obtain improved properties due to a uniform coating.

In addition to the above-mentioned advantages, at least some of the following advantages may further be obtained:
1) Reliable adhesion/tackiness of the adhesive may be obtained for different types of surfaces onto which the label will be manually dispensed or applied, e.g. during the preparation of the order (for example in the kitchen) or when labelling the various items of the order (for example cups, boxes, wraps, bags, or other packages).
2) Easy repositionability may be obtained so that the label is first applied onto a first surface and then repositioned onto another surface. For example, label may be used first in the kitchen as a note and then labelled onto the ready-made dish.
3) Easy removability may be obtained, for example for customers removing the label used as a closure or seal for a package.
4) Permanent final tack of the label may be achieved in applications where lower first tack is beneficial to reduce adhesive build up in the printer but permanent type of tack of label is preferred after dispensing on the item to be labelled.
5) Suitable chemistry either for direct or indirect food contact may be obtained.
6) Sustainability supporting the short life of such labels may be obtained, i.e. chemistry which does not create undue burden to the environment or call for any special waste management procedures compared to other waste that becomes generated in the processes and activities where such labels are used.
7) Water-based acrylic PSA may provide further benefits, such as better sustainability with less fossil based raw materials and less volatiles involved both during the manufacturing and during end use.
8) Removal of coating from the surface of the coating roll may improve production efficiency, decrease number of web breaks, and improve easiness of re-usability of the removed coating.
9) A location of the first coating unit may improve the controllability of the curtain coating.
10) A location of the second coating unit may improve the controllability of the slot die coating.
11) If the arrangement comprises both, the curtain coating at the first location, and the slot die coating at the second location, it is possible to provide many kinds of coating layers using different kind of applying speeds.

### BRIEF DESCRIPTION OF THE DRAWINGS

In the following, the invention will be described in more detail with reference to the appended drawings, in which:

FIG. 1 illustrates, by way of an example, an Sₓ,S_{y}-cross-section of a label web,

FIG. 2a-b illustrate, by way of an example, method steps according to embodiments,

FIG. 3 illustrates, by way of an example, an embodiment of a manufacturing method and an apparatus,

FIG. 4 illustrates, by way of an example, an embodiment of a manufacturing method and an apparatus,

FIG. 5 illustrates, by way of an example, adhesive stripes,

FIG. 6 show a photo from an experimental test, and

FIGS. 7a-d illustrate, by way of an example, locations of some example units, wherein

FIG. 7a illustrates, by way of an example, an example location of a curtain coating unit,

FIG. 7b illustrates, by way of an example, an example location of a slot die coating unit,

FIG. 7c illustrates, by way of an example, an example location of a coating removal unit, and

FIG. 7d illustrates, by way of an example, an example location of a nip formed between a coating roll and a reverse roll.

The figures are schematic and are intended to illustrate the general principles of the disclosed solution. Therefore, the illustrations in the Figures are not necessarily in scale or suggestive of precise layout of system components.

### DETAILED DESCRIPTION

The solution is described in the following in more detail with reference to some embodiments, which shall not be regarded as limiting.

In this specification, references are made to Figures, in which the following reference numerals and denotations are used:
Sx, Sy, Sz 3D coordinates,
WA width of an adhesive stripe,
α first angle defining a location of a first coating unit,
β second angle defining a location of a second coating unit,
λ third angle defining a location of a coating removal unit,
δ fourth angle defining a location of a nip formed between a coating roll and a reverse roll,
100 a label web,
105 release liner,
110 face, face stock,
111 first side of the face, i.e., top side,
112 second side of the face, i.e. bottom side,
120 pressure sensitive adhesive coating (PSA),
121 coating,
130 release coating layer on a face,
140 substrate,
150 adhesion-free area,
150a adhesion-free areas on the longitudinal edges,
200 label,
401 arranging a substrate, such as a face,
402 applying coating onto a coating roll,
403 arranging coating-free areas,
404 transferring coating from a coating roll onto a substrate,
405 drying the coating,
406 transferring the adhesive from a carrier material onto a face or a release liner,
407 winding the material into a roll,
500 coating unit,
501 first coating unit,
502 second coating unit,
510 coating roll,
515 nip between a coating roll and a reverse roll,
520 reverse roll,
530 adhesive removal unit, preferably comprising a blade,
560 drying unit, and
561 drying device.

In this specification term “comprising” may be used as an open term, but it also comprises the closed term “consisting of”.

Unit of temperature expressed as degrees C. corresponds to ° C.

Percentage values relating to an amount of a material are percentages by weight (wt. %) unless otherwise indicated. All percentage values refer to dry weight unless otherwise indicated.

Term “web” refers to a continuous sheet of material. The web is generally processed by moving over rollers. Between processing stages, webs may be stored and/or transported as rolls.

In this application, the term “linerless label web” refers to a continuous web comprising a face 110 and pressure sensitive adhesive 120, wherefrom the linerless labels 200, i.e. the individual labels, may be separated. The linerless label web does not comprise a release liner.

In this application, the term “label” refers to an individual label product 200 separated from the label web 100 to be applied onto an article, unless otherwise indicated. The label 200 can be adhered onto an article by using an adhesive. Thus, in this application, the terms “label” and “linerless label” refer to a product comprising the face 110 and the pressure sensitive adhesive coating 120, unless otherwise indicated.

In this application, the term “label laminate web” refers to a continuous web comprising a face 110 and a release liner, wherein a pressure sensitive adhesive 120 is left in between the face and the release liner, and wherefrom individual labels 200 may be separated.

The term “label web” may refer to a linerless label web, or to a label laminate web.

The terms “substrate” and “material web” may refer to
a linerless label web,
a release liner web,
a label laminate web, or
a carrier material web.

The term “PSA” refers to pressure sensitive adhesive(s).

Term “machine direction” refers to manufacturing direction MD of a web. Machine direction MD may also refer to a circumferential direction of a roll. Further, longitudinal direction and lengthwise direction of a web both refer to the machine direction. In this application, the term “first direction” refers to the machine direction.

Terms “cross direction” and “cross machine direction” and “transversal direction” refer to a direction that is transversal to the machine direction. In this application, the term “second direction” refers to the cross-direction CD.

The term “face” refers to a substrate of the label, also called as a face stock or a face material. In case of a plastic face material, it may also be called a face film.

In this application, the term “coating layer” may refer to a continuous coating layer, or to a coating layer comprising areas with and without coating. Thus, a coating layer may comprise areas with coating and areas without coating.

The coating may comprise, for example, coating stripes. The coating stripes may be, at least in the machine roll, continuous stripes. The coating stripes, such as adhesive stripes, may have a predetermined position and width. The coating layer may consist of the coating stripes, or other type of coating patterning. The coating layer may comprise or consist of adhesive stripes.

In this application, the term “coating” preferably refers to an adhesive coating, but the coating may alternatively be other kind of coating, such as, for example, a silicone coating.

### Label Web

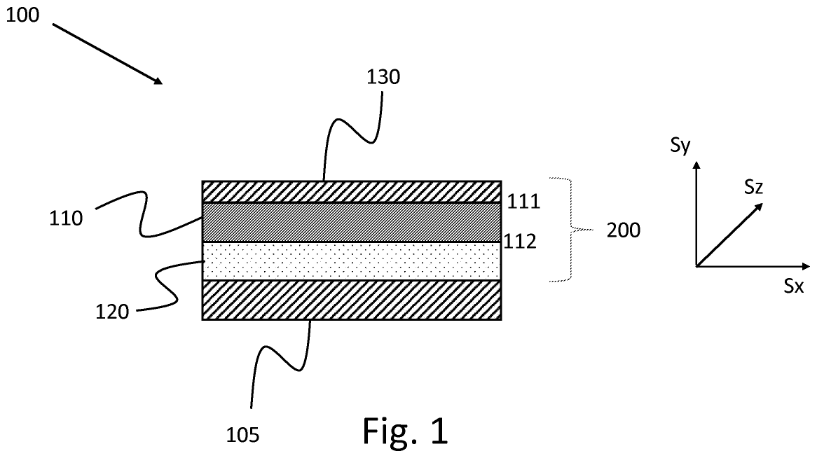

FIG. 1 illustrates, by way of an example, an Sₓ,S_{y}-cross-section of a label web 100. The label web 100 may be a linerless label web, i.e., a label web without a release liner. Alternatively, the label web may be a label laminate web, i.e., a label web comprising a release liner.

A label web 100 refers to structure comprising so called continuous face 110 and an adhesive 120 arranged on one side of the face 110, and optionally a release liner. The label web 100 is generally processed by moving over rollers. Between processing stages, the label web 100 may be stored and transported as rolls. From the label web 100, individual labels 200 may be cut.

The label web 100 can comprise or consist of
a face,
optionally, a release coating on the face,
a pressure sensitive adhesive coating, and
optionally, a release liner.

During manufacturing process of customer rolls, the linerless label web 100 is wound into a machine roll, and the machine roll is typically unwound and slit into smaller customer rolls. The customer rolls may be intermediate label product for further converting, i.e. printing and die-cutting, or they may be rolls ready to be inserted e.g. into thermal printers.

The label web may be arranged with multiple adhesive stripes. Afterwards, the wider web width of the machine roll produced in this manufacturing process may be to be slitted into a correct customer roll width. The customer roll may have one or more than one adhesive stripe, such as several adhesive stripes.

The label web 100 may comprise one or more properties from a group comprising:
Coat weight of adhesive layer 120 can be in the range of 15-20 g/m² (dry coat weight) in order ensure both; good anchorage and good tack to different type of surfaces.
Adhesive layer 120, 121 is preferably water-based adhesive layer. Further, acrylic based adhesives are more environmentally friendly and also provide more suitable temporal build-up of the final tack helping to reduce contamination of the printer.
Adhesive layer 120, 121 is arranged in adhesive stripe(s) in longitudinal direction. This ensures suitable label behavior per given end use but also helps to reduce the contamination of the printer.
optionally, special primer may not be needed between the face and PSA to enhance adhesive anchorage of the adhesive onto the face. High enough anchorage may be achieved by using high enough coat weight of the adhesive and fully drying the adhesive. This streamlines the manufacturing leaving out one additional processing phase and helping to lower the cost.

### Machine Rolls and Customer Rolls

As discussed, the formed label web 100 is typically wound up to a machine roll. The machine roll may be unwound and slit into smaller customer rolls.

The label web roll may be stored and/or transported for later processing. Label web roll may be further processed in other location.

In an embodiment, the label web can be arranged to be self-wound into the machine roll.

The label roll may be so called machine roll, or a customer roll (not shown in Figs). In the manufacturing process of the label web, the label web is typically rolled into a machine roll. Width of the machine roll, (i.e., the label web before it is cut into customer rolls), is typically a multiple of the final customer roll width. The width of the machine may be, for example, from 1 to 3 meters.

Typical machine roll diameter is from 500 mm to 1500 mm, most typically from 500 mm to 1000 mm. This means that on top of the full machine roll one layer around the roll periphery is approximately 1-5 meters long. Thus, the top layer of full machine roll may have a length, for example, from 1 m to 5 m.

Size of customer rolls depend on whether they are linered label laminate rolls provided as intermediate label product for further converting, i.e. printing and die-cutting or whether they are direct thermal printable linerless rolls ready to be inserted into thermal printers.

The labels from converted, pre-printed label laminates are often high-speed dispensed using dispensing machines. On the other hand the direct thermal linerless labels are typically manually dispensed after being manually printed, for example, in the greengrocery department of a shop.

A diameter of a customer roll, for example in direct thermal variable information printable (VIP) labels, may be between 50 mm and 150 mm making it about 10 times smaller and reflecting into the top of roll layer peripheral lengths being in the order of 0.1-0.5 meters. As understood, when looking into mid roll or near empty roll peripherical lengths, those approach the values determined by the winding core sizes. These core diameters range typically from 50-200 mm for machine rolls and for such smaller customer rolls from 5-20 mm.

A diameter of a customer roll for converting may be, e.g., 20-60 cm. For such customer rolls, a length of the customer roll may be, e.g. 500-6000 m, and a width may be, e.g., 10-50 cm.

The label web 100, after rolled into a customer roll, may be referred to as a (label) customer product roll, customer roll or product roll. Depending on a diameter of the label roll and thickness of the label material, a single roll may contain 10-6000 meters label web, such as, for example, 10-100 meters of label material (i.e., 10 to 100 meters of label web 100), or e.g. from 500 to 6000 meters of label web.

Typical label web 100 customer roll consisting of a single label width may have a width of approximately 10 to 100 mm. Quite commonly used widths can be found around in the middle of the aforementioned range, i.e. between 40 mm and 60 mm. Typical label web customer roll for converting may have a width between 10 cm and 50 cm.

In an embodiment, single machine roll may be arranged with continuous adhesive stripes in different cross-directional positions (adhesive stripe locations) and thus used to produce different type of customer rolls. The slitting process may, in some cases, be used to provide different adhesive stripe positions.

### Face

The label web comprises a face. The face 110 comprises a first side 111 and a second side 112. The first side of the face can be the top side of the face, and the second side of the face can be the bottom side of the face. The second side 112 can be an adhesive side, and the first side 111 can be a print side. The face 110 may comprise e.g. a print to provide information and/or visual effect.

The face 110 may have a monolayer structure, or it may have a multilayer structure comprising equal to or more than two layers. The face 110 is the layer that is adhered to a surface of an article through an adhesive coating.

Further, the label web 100 may contain additional layers, for example top coatings or overlaminates to protect the top surface and/or print of the label against rubbing or other external stress. Further, a primer may enable enhancing compatibility of adjacent layers or parts of the label, for example adhesion between the layers. The face 110 may contain one or more barrier layers to prevent chemical substances from migrating through a surface of the first side 111 of the face or a surface of the second side 112 of the face, or other interfaces of the label web 100, 200.

In an embodiment, the first side 111 of the face can be printable by using heat. In an embodiment, the label web comprises a direct thermal printable coating on the first side of the face.

The face 110 may comprise a paper comprising natural fibres as its main raw material. Natural fibres refer to any plant material that contains cellulose. The natural fibre may be wood based. The wood based natural fibre may be from softwood trees, such as spruce, pine, fir, larch, douglas-fir, or hemlock, and/or from hardwood trees, such as birch, aspen, poplar, alder, eucalyptus, or acacia, or from a mixture of softwoods and hardwoods. The face 110 may comprise cellulose fibers from both hardwood and softwood. A mixture of hardwood and softwood may be used to improve the internal bond strength of the face 110.

A paper suitable for the face 110 is typically so-called wood-free paper. Wood-free refers to chemical pulp, such as Kraft pulp. In accordance with an embodiment, a pulp used for making the face does not contain any kind of mechanical pulp due to high quality requirements of the face. Thus, the face 110 may be a wood-free paper comprising fibers e.g. from softwoods and/or hardwoods.

The face 110 may comprise, for example, at least one filler selected from a group comprising clay, calcined clay, kaolin, natural ground calcium carbonate, precipitated calcium carbonate, talc, calcium sulphate, and titanium dioxide. The total amount of the fillers in the face 110 is preferably less than 10 weight-%, more preferably less than 5 weight-%, and most preferably less than 3 weight-%, for example between 0.5 wt.-% and 5 wt.-%, or between 0 wt.-% and 3 wt.-%, based on the total weight of the face 110. The fillers may decrease costs of the manufactured product. However, the mineral fillers may also decrease strength properties of the face 110. Further, if the face comprises too much mineral fillers, some properties of the face 110 may be compromised. Thus, in an example, the face 110 does not comprise said mineral fillers.

The face 110 may comprise a paper which is coated with one or more coatings. For coated papers, a coat weight in the range of 1 to 12 g/m² per side (on one or both sides) may be used. The coating layer(s) may comprise at least one pigment selected from a group comprising clay, calcined clay, kaolin, natural ground calcium carbonate, precipitated calcium carbonate, talc, calcium sulphate, and titanium dioxide. Further, said coating layer(s) may comprise binders, such as starch and/or polyvinyl alcohol. The face may further comprise additive(s).

A face 110 comprising a paper may be calendered with a calender or a supercalender to obtain a high-density surface.

Alternatively, or in addition to the paper, the face 110 may comprise a filmic material such as polyethylene (PE), polypropylene (PP), or biaxially oriented polypropylene (BOPP). Also, other suitable materials, such as different types of polyesters such as polyethylene terephthalate (PET) or polyethylene(s) are possible.

The grammage of the face 110 is preferably at least 50 g/m², more preferably at least 60 g/m². Further, the grammage of the face is preferably less than 85 g/m², more preferably equal to or less than 80 g/m². Grammage may be, for example, in a range between 50 g/m² and 82 g/m² or in a range between 60 and 80 g/m². The grammage can be measured according to standard ISO536.

In an embodiment, the label web is thermally printable and the face 110 may have a static sensitivity below 90 degrees C., preferably in a range between 75° C. and 90° C. Thus, if the label web is thermally printable, the static sensitivity may be high enough so that the product is not darkening before printing, for example during transportation. However, said static sensitivity level is sensitive enough to be thermally printable. In another embodiment, the label web 100 is not thermally printable and it may not have said static sensitivity.

The face 110 may have an optical density of below 25 mJ/mm², preferably below 20 mJ/mm², and more preferably below 15 mJ/mm², such as between 10 mJ/mm² and 15 mJ/mm². Too high optical density may cause challenges to the product. Further, low optical density may speed up the label printer. Moreover, thanks to low enough optical density, the label may not cause too many demands for printers.

The face 110 may have a caliper in a range between 60 μm and 85 μm, measured according to ISO534. If the face it is too thin, the label web 100 may be difficult to handle. For example, if the face is very thin, a stiffness of the label web 100 may go too low causing the label web 100 to be too sloppy. Thus, the label web may be difficult to manufacture and/or the label web may cause problems e.g. if used with a printer.

The top side of the label web 100 may have a smoothness at least in a range between 350 sec and 550 sec (Beck), measured according to standard ISO5627. For example, by using a face comprising a paper, if the paper is too rough, the life of a print head (if the label is to be printed) may decrease too much.

The face may comprise a release layer such as a silicon layer on top of the face. The release layer will smooth the linerless label (web) and, hence, the product may be better for printers. Thus, the face 110 may be pre-coated and the pre-coat may have effect of providing smoothness to the substrate, i.e. the top surface of the face 110. Smoothness of the face 110 comprising paper has positive effect on printing, for example by providing better resolution. The pre-coat may have positive effect on printing quality. In an embodiment, the first side of the label web 100 may have a smoothness of equal to or more than 1000 see (Beck), measured according to standard ISO5627.

The label web may have a brightness higher than 85% (R457) when measured according to standard ISO2469. Therefore, the label web 100 may look nice. Further, high brightness may create a contrast between the symbols/letters. Thus, if the letters comprise some machine-readable letters, the letters may be easily read thanks to said brightness.

The label web 100 may have an opacity higher than 80%, such as in a range between 80 and 90, when measured according to standard ISO2471. Thanks to said opacity, the surface of the label web 100 may not be too transparent for a machine, or a human eye, to read.

The face 110 and/or the label web may have a tensile strength in the machine direction (i.e., the first direction) higher than 40 N/15 mm, preferably higher than 45 N/15 mm, when measured according to standard ISO1924/2. Thus, dimensional stability of the label web 100 may be improved, which may have a positive effect on the manufacturing process and a printing process of the label web.

The face 110 and/or the label web 100 may have a tensile strength in the cross direction (i.e., the second direction) higher than 10 N/15 mm, when measured according to standard ISO1924/2. Thanks to said strength, a dimensional stability of the label web 100 may be improved, which may affect manufacturing process and printing process.

The face 110 may have a paper substrate manufactured from FSC™-certified (mix credit) pulp. Thus, the face may comprise or consist of environmentally friendly material. Thus, the label web 100 may be better for the environment than some other kind of face materials.

### Release Coating of the Face

The label web 100 can have a release coating 130 on the first side 111 of the face 110, i.e., top of the face 110, as illustrated in FIG. 1. This embodiment is particularly advantageous if the label web is the linerless label web.

According to an embodiment, the release coating 130 is coated and cured on the top of the face 110 before either directly coating and drying the adhesive coating 120, 121 on the bottom of the face 110, or alternatively, before transferring the separately dried adhesive coating 120, 121 on the bottom of the face 110. In other words, preferably a readily release coated face 110 is provided into the process of adding adhesive coating 120,121 on the opposite side of the face 110. The benefit of these embodiments is that the release coating 130 may be provided as a completely separate step and potentially in completely separate facility.

Thus, the method for manufacturing a label web may comprise the following step:
supplying a face 110 comprising a release coating.

The separate release coating layer 130 may be used to improve the self-woundability of a linerless label web. The linerless label web with pressure sensitive adhesive 120 on its one side (bottom side) and release coating 130 on its other side (top side) can be self-wound around itself without tendency of blocking the adjacent layers of the label web to each other.

The release coating 130, may be a silicone-based or non-silicone-based release coating. Preferably, the release coating comprises or consists of silicone-based release coating. PA silicone-based release coating 130 may comprise UV curable silicone, for example UV free radical silicone or cationic UV silicone. The release coating 130 may comprise one or more layers of release coating 130.

Non-thermally curable release coatings are preferable, for example UV curable silicone, because curing of such layers may not heat the substrate.

A further function of the release coating 130 may be that it may provide a lower friction level against a print head and/or against other mechanical components of the printer minimizing wear of those components and minimizing adhesive residue built up. Thus, in an example, the release layer 130 is used in order to lower friction against the print head of a printer.

In an embodiment, wherein the label web is the linerless label web, the adhesive coating is applied on top of release coating 130 of the face and dried therein, or alternatively, separately dried adhesive coating is transferred on top of this release coating 130. In these embodiments, when the web is self-wound into a roll, the pressure sensitive adhesive coating 120 becomes anchored onto the bottom side of the face 110 which is now without release coating.

When unwinding the roll such linerless web has the adhesive coating 120 remaining now on the bottom of face 110 and the release coating 130 remaining on top of the face 110.

### Label Laminate

The label web 100 may be a label laminate web. The label laminate web typically comprises a face layer and a release liner, which are laminated together, wherein an adhesive layer is provided between the release liner and the face layer. In this application, the term “label laminate” refers to so called pressure sensitive label laminates and self-adhesive label laminates.

### Release Liner of a Label Laminate

If the label web 100 is the label laminate web, it comprises a release liner.

The release liner comprises at least a support layer, and preferably a release coating layer applied on at least one side of the support layer. The support layer may comprise e.g., a paper.

The release liner refers to a product comprising a support layer as base material and at least one release coating layer on the support layer. In other words, the support layer may be coated with a thin layer of release agent, such as silicone. Therefore, the release liner may be easily removed from the face layer when the label is adhered to a substrate.

The release liner 105 can be used to protect the adhesive layer, and to allow efficient handling up to the point where the label is dispensed and adhered to a substrate surface.

The release liner 105 may comprise a paper comprising natural fibres as its main raw material. Natural fibres refer to any plant material that contains cellulose. The natural fibre may be wood based. The wood based natural fibre may be from softwood trees, such as spruce, pine, fir, larch, douglas-fir, or hemlock, and/or from hardwood trees, such as birch, aspen, poplar, alder, eucalyptus, or acacia, or from a mixture of softwoods and hardwoods. The release liner 105 may comprise cellulose fibers from both hardwood and softwood. A mixture of hardwood and softwood may be used to improve the internal bond strength of the release liner 105.

The release liner may comprise, for example, coated paper such as clay coated kraft paper (CCK), machine finished kraft paper (MFK), machine glazed paper (MG), super calendered kraft paper (SCK), vegetable parchment, glassine, or greaseproof paper.

As discussed, the release liner comprises a support layer. A grammage of the support layer may be at least 35 g/m², and preferably at least 40 g/m², and preferably less than 100 g/m², more preferably equal to or less than 90 g/m². Grammage of the support layer may be, for example, in the range of 38 to 100 g/m² or between 40 and 90 g/m². This grammage can be particularly suitable for use in an automated high-speed labelling process.

A density of the support layer may be equal to or less than 1300 kg/m³, preferably in the range of 1000 to 1200 kg/m³, most preferably in the range of 1035 to 1150 kg/m³. This density can be particularly suitable for release libers and for use in an automated high-speed labelling process.

The support layer can be coated with a release coating. The release coating of the release liner may be a silicone-based or non-silicone-based release coating. Preferably, the release coating comprises or consists of silicone-based release coating. Silicone-based release coating may comprise UV curable silicone, for example UV free radical silicone or cationic UV silicone.

The release coating of the release liner may comprise one or more layers of release coating.

### Label

A label 200 (also called as a label product) is a piece of material to be applied onto an article. Articles of different shapes and materials may be used together with the labels 200. An article may be a package. Properties and requirements for a label 200 may be different depending on the end use in question. Some non-limiting examples of end uses, and their typical parameter requirements are described in Table 1.

A label 200 comprises at least the face 110 and an adhesive layer. A typical way to adhere the label 200 onto an article is by use of the PSA coating 120. Therefore, the adhesive coating 120 comprises pressure sensitive adhesive (PSA). A label 200 comprising pressure sensitive adhesive may be referred to as a pressure sensitive adhesive label. Pressure sensitive adhesive labels may also be referred to as self-adhesive labels.

The labels 200 comprising PSA can be adhered to most surfaces through an adhesive layer without the use of a secondary agent, such as a solvent, or heat to strengthen the bond. In that case, the adhesive is pressure sensitive as such. Alternatively, the adhesive may be activatable in order to be pressure sensitive. The PSA forms a bond when pressure is applied onto the label at ambient temperature (e.g. between 15 and 35° C.) or for cold applications even under freezing temperatures below 0° C., adhering the label to the item to be labelled. Examples of pressure sensitive adhesives include water-based (water-borne) PSAs, solvent based PSAs, and hot-melt PSAs. A label may, alternatively or in addition, comprise other adhesive(s).

In this application, the pressure sensitive adhesive has typically inherent pressure sensitivity without need for separate activation before being able to be dispensed onto an article to be labeled.

The label according to this application can be attached onto the labelled item primarily via the pressure sensitive adhesive covering at least partially the bottom side of the label.

The label web of the invention can be a label laminate comprising a release liner, or a tape-type label that can be self-wound onto itself in a roll without need for additional release liner.

Labels may be used in wide variety of labelling applications and end-use areas, such as labelling of food, home and personal care products, industrial products, pharmaceutical and health care products, beverage and wine bottles, other consumables etc. Labels enable providing information, like product specification, on the labelled product(s). Information, e.g. print of a label, may comprise human-readable information, like image(s), logo(s), text, and/or machine-readable information, like bar code(s), QR (Quick Response) code(s). One subcategory of labels are so-called Variable Information Print (VIP) labels. These labels are at least partly printed just before dispensing them onto the item to be labelled and carry product specific information on that individual item to be labelled. VIP labels are used, for example, in retail weighting scales for fruits, vegetables, meat and other items sold per weight. Other labels which are individually printed per need are different type logistic labels containing shipment or product specific information, bus or train tickets or other tickets etc.

### Coating

In this application, the term “coating” refers to any coating 121 suitable to be applied in a contactless manner onto a coating roll for forming a coating layer on any layer of a label web.

The coating is applied onto a substrate via a coating roll so that the coating is first applied in a contactless manner onto the coating roll and then transferred onto the substrate in a nip. The substrate preferably travels, in the nip, to a direction opposite to a direction of the coating roll.

The coating may have a viscosity level of at least 100 and equal to or less than 1000 cP (or mPa-s) measured using a Brookfield rotational viscometer at room temperature (23 C+/−2 C) using spindle nbr 3 and rotational speed of 100 rpm.

For slot die coating, viscosity level of the coating may be less than 1000, preferably less than 700, more preferably less than 500 and most preferably less than 300. Further, for slot die coating, viscosity level of the coating may be at least 100, preferably at least 120, more preferably at least 150, and most preferably at least 180.

For curtain coating, viscosity level of the coating may be equal to or less than 1000, preferably less than 900, more preferably less than 800 and most preferably less than 700. Further, for curtain coating, viscosity level of the coating may be at least 100, preferably at least 200, more preferably at least 300, and most preferably at least 400.

A thickness of the coating layer may be, e.g. at least 1 μm, preferably at least 3 μm, and most preferably at least 5 μm. Further, thickness of the coating layer may be equal to or less than 50 μm, preferably equal to or less than 40 μm, more preferably equal to or less than 30 μm, and most preferably equal to or less than 20 μm.

For example, thickness of a top coating, such as a barrier coating of the label web, may be in a range between 1 μm and 10 μm. Further, thickness of the adhesive coating may be, for example, between 10 and 30 microns.

The coating 121 may be e.g. a primer or an adhesive. Advantageously, the coating 121 is a pressure sensitive adhesive. Most advantageously, the coating 121 is a pressure sensitive adhesive comprising water-based acrylic adhesive.

### Substrate

The substrate may be a face, a release liner, or a carrier material. The substrate may be a paper or a plastic film. The substrate may have a silicone layer on its surface.

In an embodiment, a grammage of the coating layer formed on the substrate is at least 5 gsm, or at least 10 gsm, such as in a range between 5 gsm and 100 gsm.

Some properties of the face and the release liner are discussed above.

The carrier material may be used to transfer the coating from the coating roll onto a label web. The carrier material may be any kind of material layer suitable to transfer the coating from the coating roll onto the face or the release liner, such as a paper, a plastic, or a metal.

For the purpose of this specification, the term “carrier material” may refer, e.g., either to an endless belt or to a batch of a web material. The carrier may comprise at least one release coating. The carrier material, if used, may be a belt, for example a silicone belt, a plastic belt, such as a nylon belt, or a metal belt, such as a steel belt. Alternatively, the carrier material may be a batch of a web material, wherein the carrier material may be a filmic web material, preferably a polyethylene terephthalate (PET) web or other thin filmic material tolerating the drying temperatures. The belt may comprise a closed surface. An external surface of the belt may comprise roughness of 0.2-3.0 pm, preferably 0.4-1.0 pm, according to PPS 10 of ISO 8791.

### Adhesive Coating

The label 200 and the label web 100 disclosed herein comprise an adhesive coating 120. The adhesive coating is a pressure sensitive adhesive coating, which may also be called a self-adhesive coating.

It should be noted that a certain coating thickness (coat weight) is needed in order to obtain the water-based PSA as a uniform, defect free layer. The adhesive layer, preferably in form of adhesive stripes, may have a thickness of at least 10 μm, preferably at least 12 μm or at least 14 μm, and most preferably equal to or more than 16 μm. The coat weight of the PSA needs to be high enough to fill the pores of the surface. Thus, the thickness of the PSA may depend on the surface to be coated. Further, the amount of the PSA needs to be high enough to attach the label onto the surface of an object. Advantageously, the thickness of the adhesive coating is equal to or less than 40 μm, preferably equal to or less than 30 μm, more preferably equal to or less than 25 μm, and most preferably equal to or less than 20 μm. The thickness of the adhesive coating may be, for example, between 16 and 20 microns.

The adhesive coating, such as adhesive stripes, may have a target coat weight in a range between 10 and 30 g/m² (dry coat weight). Further, the adhesive layer 120 may have a target coat weight in a range between 15 g/m² and 25 g/m² (dry coat weight), most preferably in a range between 16 g/m² and 21 g/m². Preferably, to obtain an adhesive layer that is good enough to attach the label to the surface of an item without being too expensive, the adhesive is a water-based PSA, which is acrylic-based.

In an embodiment, the label web 100 comprises adhesive stripes 120, wherein the thickness of the adhesive stripes remains constant both in machine and cross-direction, however certain small deviations from the target thickness value may exist due to manufacturing tolerances. Therefore, it is possible to obtain an adhesive layer comprising adhesive stripes that is good enough to attach the linerless label to a surface of an item without being too expensive.

The pressure sensitive adhesive coating layer 120 may comprise one or more layers of adhesive. If the PSA coating 120 comprises more than one layer of adhesive, the adhesive coating may have improved smoothness. For example, if the first adhesive coating layer comprises any small holes, these may be filled with the second adhesive coating layer.

Pressure sensitive adhesive may be a permanent adhesive, or it may be removable or repositionable, or even ultra-removable adhesive. Further, pressure sensitive adhesives may have a working temperature from ambient to freezer temperatures.

The pressure sensitive adhesive 120 may have a maximum tack value of equal to or more than 3 N, more preferably equal to or more than 4 N measured on glass according to FINAT test method FTM9. Said values may be suitable performance values for the pressure sensitive adhesive coating 120 of the label web 100, 200.

The pressure sensitive adhesive may be used for permanent label web or removable label web. For removable label web, the maximum tack value is preferably between 3 N and 6 N measured on glass according to FINAT test method FTM9. For permanent label web, the maximum tack value is preferably equal to or more than 8 N, more preferably equal to or more than 10 N, and most preferably equal to or more than 17 N, measured on glass according to FINAT test method FTM9.

In an embodiment, the pressure sensitive adhesive 120 has a maximum tack value of equal to or less than 12 N, more preferably equal to or less than 6 N and most preferably between 3 N and 6 N as measured on glass according to FINAT test method FTM9. Said values may be particularly suitable performance values for the pressure sensitive adhesive coating 120 of the label web 100 for quick service restaurants.

In another embodiment, the pressure sensitive adhesive 120 has a maximum tack value of equal to or more than 8 N, more preferably equal to or more than 10 N as measured on glass according to FINAT test method FTM9. Said values may be particularly suitable performance values for the pressure sensitive adhesive coating 120 of the label web 100 for industrial food or retail labeling.

In another embodiment, the pressure sensitive adhesive 120 may have a maximum tack value of equal to or more than 15 N, more preferably equal to or more than 17 N as measured on glass according to FINAT test method FTM9. Said values may be particularly suitable performance values for the pressure sensitive adhesive coating 120 of the label web 100 for logistic and warehouse.

Properties and characteristics of the PSA used herein may vary depending on the end use of the label in question. Some properties are illustrated by Table 1 showing some preferred values and factors for the adhesives for different end uses.

TABLE 1

| | | | | | Quick |
|---|---|---|---|---|---|
| | | Retail | Logistic, | Industrial | service |
| | | labelling | warehouse | food | restaurant |
| Labelling | (° C.) | 18 . . . 25 | 10 . . . 25 | −2 . . . 8 | 18 . . . 30 |
| environment | | | | | |
| Labelling | (° C.) | 8 . . . 25 | 10 . . . 25 | −20 . . . 8 | 8 . . . 60 |
| environment | | | | | |
| (substrate) | | | | | |
| Environment | | Dry | Dry | condens. | condens. |
| (substrate) | | | | Exists | exists |
| Service | (° C.) | 4 . . . 25 | 0 . . . 25 | −20 . . . 25 | 18 . . . 30 |
| temperature | | | | | |
| Adhesive | | permanent | permanent | permanent | removable |
| characteristics | | | | | |
| Adhesion | N/ | ≥8 | ≥17 | ≥10 | 3 . . . 6 |
| (tack) | 25 mm | | | | |
| | FTM9 | | | | |
| Coat weight | (g/m²) | 15 . . . 20 | 18 . . . 25 | 15 . . . 20 | 15 . . . 20 |
| (dry) | | | | | |

Within context of this specification, the pressure sensitive adhesive is preferably water-based PSA. Water-based adhesives can provide better sustainability with less fossil based raw materials and less volatiles involved both during the manufacturing and during end use.

Further, it might be easier to achieve a good anchorage level with water-based PSA onto the face 110 disclosed herein even without any additional primer being used. Thus, in an embodiment, the water-based pressure sensitive adhesive 120 is directly in contact with the face 110, without any further coating layers between the PSA and the face. Thus, in an embodiment, the adhesive exhibits sufficient anchorage to the face 110 and resistance to face stock penetration, such that priming is not required. Flat adhesion profile over extended dwell-time and/or sufficient cohesion in order to resist winging on curved surfaces may be preferred. However, in an embodiment, the label web comprises said priming.

Still further, water-based adhesives may be designed to have approval for direct or indirect food contact (food-safety), which is a requirement in certain food related label end use areas.

The pressure sensitive adhesive can be suitable for high coating speeds. Preferably, the adhesive gives reticulation free coatings at coat weights of 10-30 g/m² (dry coat weight).

Preferably, the water-based PSA is acrylic-based, i.e., the adhesive is most preferably a water-based acrylic adhesive. The water-based acrylic PSA may have many advantages over other kinds of PSAs. Water-based acrylic PSA may be environmentally friendly. Further, tackiness of the product may improve thanks to the water-based acrylic adhesive. Furthermore, hot melt adhesives may cumulate more easily e.g. into cutting machines than water-based acrylic adhesives.

Moreover, acrylic adhesives may have a longer open time, hence, label web 100 comprising water-based acrylic PSA may be removed after some seconds or minutes, if needed. On the contrary, hot melt adhesives cannot typically be removed from a surface, even if attached onto a wrong surface. Thus, removability of the water-based acrylic adhesive may be better than removability of the hot melt adhesives. Moreover, peel values of the acrylic based adhesive typically differ from peel values of the hotmelt based adhesives. Therefore, the water-based acrylic adhesive may be the most preferred adhesive for the novel label web.

The water-based acrylic adhesive may be a tackified acrylic adhesive. The tackified acrylic adhesive may be used to provide aggressive adhesion to a surface.

The adhesive coating 120, 121 may be plasticizer-free. The plasticizer-free adhesive may be used e.g. on thermal papers (including economy grades) without issues of premature image development or image fade. This may have several advantages as plasticizers may migrate into the product and cause some problems. For example, food safety might be compromised.

The adhesive coating may comprise at least one surface-active agent. The surface-active agents, in general, are compounds that lower the surface tension (or interfacial tension) between two liquids, between a gas and a liquid, or between a liquid and a solid.

In an embodiment, the adhesive coating may comprise at least one surface-active agent. The adhesive coating may comprise, for example, two different surface-active agents, such as an emulsifier and a wetting agent.

In an embodiment, the adhesive coating comprises the wetting agent. The wetting agent may be added into the adhesive coating to improve the coating process of the adhesive coating. The wetting agent may increase spreading and penetrating properties by lowering a surface tension. The person skilled in the art knows the wetting agents.

Water-based acrylic adhesive provides less aggressive first tack meaning that after being opened from the label roll, the immediate tack of the PSA when guided through the printer is less aggressive compared, for example to hot melt-based PSAs. This helps, together with other features of the label, to minimize the adhesive residue build up inside a printer. The final tack builds up only after the label has been dispensed and left on the labelled item for a longer time. The label might even be removable over a certain period of time (minutes), before building a more permanent type of tack. Specific properties of PSA naturally depending on the exact formulation of the adhesive and surface materials to be labelled.

There are multitude of requirements placed on the linerless label product in order to provide cost-efficient, efficient, and trouble-free operation in a user friendly and sustainable manner.

The adhesive coating 120 may comprise both, areas with adhesive, and areas without adhesive. Total coverage of the adhesive coating can be up to 100%, preferably equal to or less than 80%, more preferably equal to or less than 60%, and most preferably equal to or less than 50%, calculated from the total area of the second side of the face. In addition, the total coverage of the pressure sensitive adhesive coating may be equal to or more than 10%, more preferably equal to or more than 30%, and most preferably equal to or more than 40%, calculated from the total area of the second side of the face. The adhesive free areas may decrease manufacturing costs, be good for the environment, and prevent an accumulation of the adhesive coating 120 to a blade and rolls of a label printer.

For some end uses, it may be essential to leave continuous adhesion-free areas/stripes 150a near the longitudinal edges of the label web 100. These adhesion-free areas/stripes 150, 150a near the longitudinal edges or on the longitudinal edges may correspond to minimum of 10%, or of 20% or even more than 30% of the total width of the label web 100. The rather wide non-adhesive area on the outer edges of the label may prevent any bleeding of the adhesive in the label roll and aid keeping the printer mechanics clean. Thus, it may be possible to ease travel of the label inside the printer and/or to help to be able to grip the labels with fingers not touching the sticky PSA.

In an embodiment, the adhesive coating may be in a form of adhesive stripes having a width in a range between 3 and 8 mm. This may provide cost-efficiently good properties for the linerless label web. Further, the usage of adhesive stripes may be environmentally friendly solution. Still further, improved properties, for example, for printers as well as for the labelling purpose may be obtained.

In an embodiment, the label web 100 comprises adhesion-free areas 150a between two adhesive stripes, the adhesion-free areas having a width in a range between 1 mm and 25 mm, more preferably in a range between 2 mm and 15 mm, and most preferably in a range between 4 mm and 8 mm. Further, the width of each adhesive stripe may be equal to or less than the width of the adhesion-free area 150.

The adhesive may be arranged as stripes along the longitudinal direction (i.e. the first direction) of the label web 100. Thus, in transversal direction (i.e. in second direction) of the label web 100 the face 110 may comprise alternating areas with and without adhesive. Arranging adhesion-free stripes/areas 150, 150a along the label web 100 may be of help in manual handling and/or dispensing of the label. Further, arranging adhesion-free stripes/areas along longitudinal edges of the label web 100, may be advantageous from the printer point of view. Therefore, contamination of the printer parts by the adhesive may be at least diminished. Finally, from the economic and environmental point of view it is favorable to provide the label 200/label web 100 with the adhesive solely on parts of the label necessary for providing the desired adhesion.

Advantageously, the adhesive covers between 10% and 90% of the total area of the second side of the face 110. The preferable cover depends on the end use of the label web. Thanks to the novel solution, it is possible to provide many kinds of shapes for the coating, such as the adhesive.

The face 110 is attached to another surface with the adhesive coating 120 when the label 200 is used. Thus, when label 200 is used, the adhesive coating 120 bonds the label 200 to the surface of an item.

The usage of the coating stripes may, in some cases, cause problems for the manufacturing process of the label web. For example, the faster you drive, the more problematic adhesive removal from a web may become. Thus, the driving speed of the web may be reduced. Thanks to the coating roll having hard surface, the coating may be efficiently removed from the coating roll in order to obtain coating stripes. Thus, problems relating to adhesive removal from the web may be prevented without of decreasing the driving speed of the web.

In an embodiment, width of an adhesive free area (determined in the cross direction) between two adjacent adhesive stripes is equal to or more than a width of each said adhesive stripes. This embodiment may have several technical effects and advantages, such as
No adhesive bleeding/oozing, and
Adhesive residue may be reduced in any parts contacting the web during manufacturing (coating, slitting) or end use (printer).

The total coverage of the pressure sensitive adhesive coating, calculated from the total surface area of the second side, may be equal to or more than 10%, preferably equal to or more than 20%, more preferably equal to or more than 30%, and most preferably equal to or more than 50%, calculated from the total surface area of the second side of the face. Further, the total coverage of the pressure sensitive adhesive coating, calculated from the total surface area of the second side, may be equal to or less than 100%, more preferably equal to or less than 70%, and most preferably equal to or less than 60%, calculated from the total surface area of the second side of the face. The non-adhesive areas 150, 150a between the adhesive stripes may prevent bleeding of the adhesive in the label roll and aid keeping the printer mechanics clean. Yet, the total PSA areas is wide enough to provide good enough traction in the printer rolls in order to traction the label through the printer.

In an embodiment, the linerless label (web) 100, 200 comprises adhesion-free areas 150a between two adjacent adhesive stripes, the adhesion-free areas having a width in a range between 1 mm and 25 mm, more preferably in a range between 2 mm and 15 mm, and most preferably in a range between 4 mm and 8 mm. Further, the width of each said adhesive stripe may be equal to or less than the width of the adhesion-free area 150.

In an embodiment, the adhesion-free area 150 and the adhesive stripe(s) 120 adjacent to said adhesion-fee are 150 may both have a width in a range between 3 and 8 mm. Further, the width of said adhesive stripe may be equal to or less than the width of the adhesion-free area 150. This may provide good properties for the linerless label web.

Thanks to the novel solution, it is possible to obtain a label web 100 in a cost-effective manner, which label web 100 may have improved properties for the manufacturing process. Still further, improved properties, for example, for printers as well as for the labelling purpose may be obtained.

Thus, as discussed, adhesive stripes may have several advantages, such as improving production efficiency of the label web while maintaining good (or even improved properties) for the end users.

### Some Example Parts of an Arrangement

The novel label web may be manufactured e.g. by using at least some method steps and/or units described in this specification.

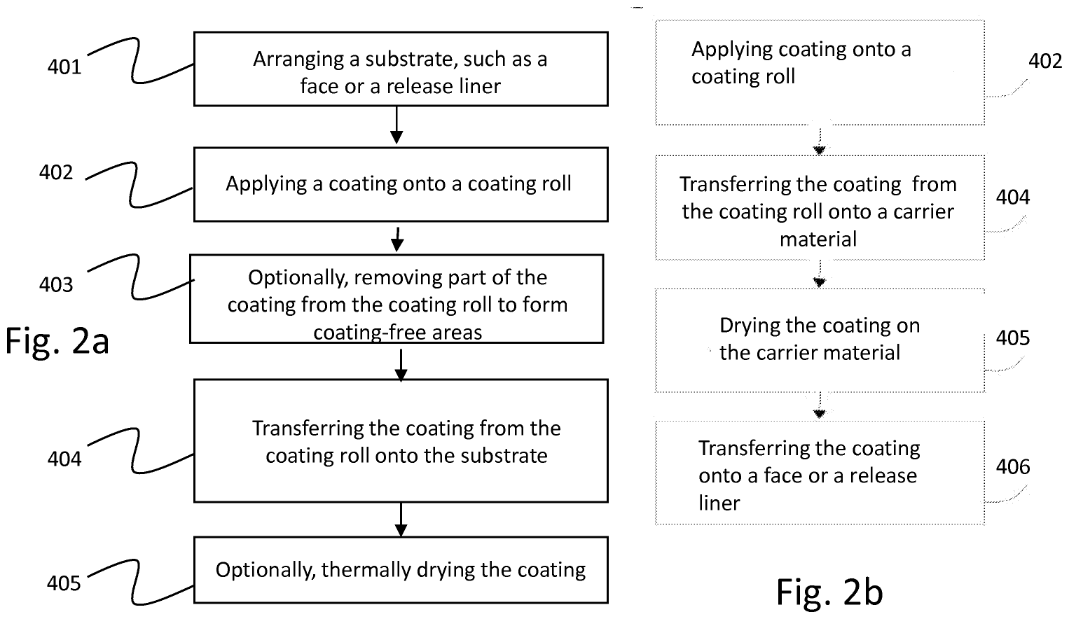

FIGS. 2a to 4 and 7a to 7d illustrate some example units and method steps for manufacturing the label web.

### A Contactless Coating Unit

The coating can be applied by using a contactless coating unit. The contactless coating unit is used for applying the coating onto a coating roll. The contactless coating unit refers to a coating unit that is not directly touching a substrate onto which a coating is applied.

In the contactless coating according to this application, an applicator applying coating may not be directly in physical contact with the coating roll, but there is a gap between the surface of the coating roll and the applicator. Therefore, the coating unit may comprise an applicator, which feeds a coating in a contactless manner onto the coating roll. Thus, only the coating will be in contact with the substrate, not the applicator.

The contactless coating unit can be pre-metering unit, i.e. the coating is pre-metered in the coating unit before it becomes applied on to the coating roll. In other words, the predetermined wet coating thickness is achieved without any further means to adjust the thickness of the wet coating layer. The metered coating can be fed onto a surface of the coating roll in order to obtain the desired coat weight. This kind of contactless coating method may improve evenness of the coating layer, even with a substantially thin coating layer. Further, the use of pre-metered coating method minimizes any unnecessary circulation of the coating liquid retaining its properties as well as possible.

The arrangement may comprise at least one coating unit arranged to apply a coating on to a surface of a coating roll. The arrangement may have equal to or less than two coating units which are arranged to apply a coating on to a surface of a coating roll. Most preferably, the arrangement has only two coating units which are arranged to apply a coating on to a surface of a coating roll.

At least one coating unit that is arranged to apply a coating on to a surface of a coating roll can be contactless coating unit. Preferably all coating units that are arranged to apply a coating on to a surface of a coating roll are contactless coating units.

The coating unit(s) arranged to apply a coating on to a surface of a coating roll are preferably selected from the following list: a curtain coating unit, a slot die coating unit, a multi slot die coating unit, and a slide coating unit.

The coat weight can be metered, e.g., by adjusting the following parameter(s):
Solid content of the coating material, and/or
Pumping speed of the coating, and/or
speed of the coating roll.

During the coating process, temperature of the coating may be, e.g. between 15° C. and 30° C., preferably between 20° C. and 25° C. The technical effect of the temperature is to provide substantially even coating on the substrate. Further, easiness of applying the coating can be improved. Therefore, by controlling the temperature level so that the temperature of the aqueous solution is not too high or too low, it may be possible to obtain both, good viscosity for the aqueous solution and good evenness for the coating layer. Further, the production costs may be decreased. Thus, advantageously, the temperature level is not too low nor too high.

Advantageously, the arrangement comprises the curtain coating unit. Alternatively, or in addition, the arrangement may comprise the slot die coating unit.

In an embodiment, the slot die coating unit is a multi-slot die coating unit. In an embodiment, the slot die coating unit is a single slot die coating unit.

In an embodiment, the curtain coating unit provide one layer of coating. In an embodiment, the curtain coating unit is a slide coating unit providing more than one layer of coating.

The novel coating method may improve the quality of the label product itself but also significantly improve the effectiveness and usability of the manufacturing method in several ways.

Starting from the coating method, the pre-metered, non-contact coating unit(s) improve the accuracy and quality of the coating layer applied onto the coating roll. The carefully designed geometrical arrangement of the coating unit(s) respect to the coating roll allow easy access and adjustability of the coating unit(s) as well as selection of suitable unit or units per the given label product needs. This allows efficient manufacturing of even shorter production runs.

Non-contact coating method based on applying the coating first onto a coating roll may decrease number of web breaks on a label machine. Thanks to the usage of the coating roll, and (optional) coating removal unit removing part of the coating from the coating roll, quality of a substrate may not be as critical as for many other coating methods. Further, for example, patterned coatings can be easily obtained because part of the applied coating can be removed against a smooth, hard surface of the coating roll.

In an embodiment, coating may be partially removed from the coating roll in a position allowing easy collection of the removed coating. Further, the coating liquid removed from the hard and non-absorbing coating roll surface remains clean and without contaminants and can thus be recirculated back to be reused. Finally, all the aforementioned benefits arising from the selection of the pre-metered and contactless coating methods and arranging them in optimal geometrical locations to coat the coating roll and further transferring the coating onto the label substrate improve the quality of the final label product.

Machine speed of the coating process may be, for example, 20-800 m/min. Thus, a speed of the substrate may be in a range between 20 m/min and 800 m/min when the coating is transferred from the coating roll onto the substrate.

Slot die coating may be particularly useful for slower web speeds, while curtain coating may be particularly useful for higher web speeds. Further, slot die coating may be useful e.g. for small orders.

In an embodiment, the arrangement comprises two coating units, i.e., the slot die coating unit and the curtain coating unit. In this embodiment, only one of said coating units may be used to apply coating at any single time. The coating unit selected to apply coating may be determined according to grade to be manufactured and/or length of label web to be produced. Thus, different grades can be manufactured by using coating unit that best suits the purpose of the grade to be manufactured. This may significantly decrease time needed to change from one grade to another grade. Thus, shut down time of the label machine may be substantially decreased, which may significantly improve a production efficiency of the label machine.

### First Coating Unit

The coating can be applied by using a first application unit. The first application unit can be a curtain coating unit.

Thus, a contactless coating unit may be a curtain coating unit, and the coating layer can be formed by using a curtain coating method. Thus, in an embodiment, thickness of the coating is controlled contactlessly by using a curtain coating method.

With a curtain coating technology, it is possible to obtain one or more than one uniform coating layers. The technical effect of curtain coating is that it may be possible to obtain cost efficiently a uniform coating layer. In a case of more than one coating layer, the curtain coating unit is preferably a slide die coating unit.

Curtain coating is preferably used for high speed labeling grades. Too low speed may decrease a quality of the formed coating. Speed of the coating roll, while using the curtain coating, may be at least 250 m/min, preferably at least 300 m/min, and most preferably at least 350 m/min. In addition, speed of the coating roll, while using the curtain coating, may be equal to or less than 800 m/min. Thus, it is possible to obtain cost-efficiently pre-metered high quality coating layer on a surface of a coating roll.

In the curtain coating, the coating is preferably applied from above onto a surface of the coating roll so that the coating falls in an angle α substantially perpendicular to the uppermost surface of the coating roll.

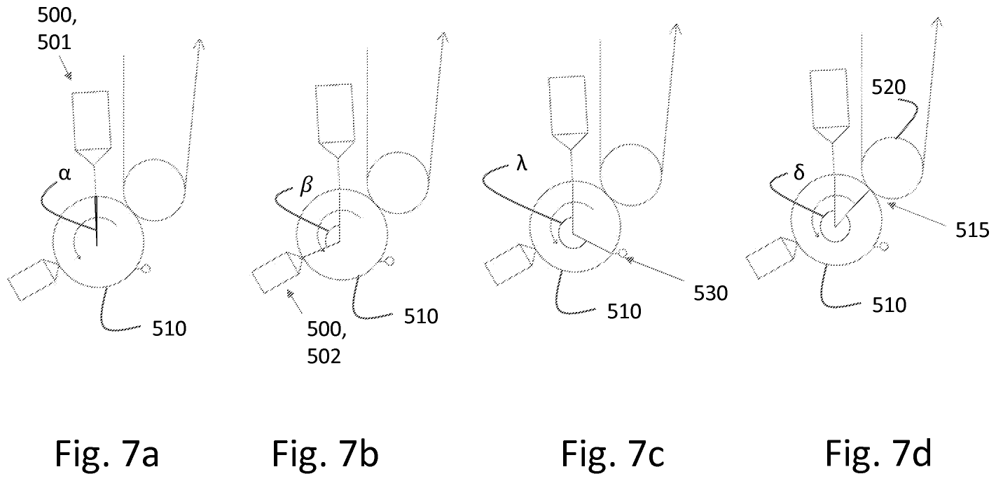

A location of the first coating unit (shown in FIG. 7a) is preferably selected so that a first angle α
that is measured in a travel direction of the coating roll between
   a vertical line formed from a center of the coating roll to an uppermost point of the surface of the coating roll, and
   a first line formed from the center of the coating roll to a first point of a coating roll, the first point defining a point wherein the first coating unit applies the coating on to the coating roll,
      is approximately 0°, for example in a range between 0° and 10°, or in a range 0° and 5°.

Thanks to the location of the first coating unit, it is possible to add several units, such as the first coating unit, a second coating unit, a coating removal unit, and a transferring nip, around the coating roll. Further, thanks to said location, the obtained coating layer may have improved properties compared to other locations.

Thanks to the curtain coating, the coating layer(s) can be substantially uniform, continuous layers, hence, number of holes may be decreased. Thus, there may not be e.g. any uncoated areas having a surface area of greater than 1.5 cm². Still further, the solubility of the aqueous solution may not be as critical as, e.g., with spraying nozzles. Moreover, the curtain coating does not leave scratches.

### Second Coating Unit

The arrangement may comprise a second coating unit for applying the coating onto the coating roll. Thus, the first coating can be applied by using a second application unit. The second coating unit may be downstream of the first coating unit.

The second application unit can be a slot die coating unit. In an embodiment, the slot die coating unit is a multi-slot die coating unit providing more than one coating layer on a surface of the coating roll. In another embodiment, the slot die coating unit may provide only one coating layer.

Slot die coating is preferably used for low speed labeling grades. Too low speed may decrease a quality of the formed coating. Speed of the coating roll, while using the slot die coating, may be less than 800 m/min, but preferably the speed of the coating roll, while using the slot die coating, is less than 400 m/min, more preferably less than 350 m/min, and most preferably less than 300 m/min. In addition, speed of the coating roll, while using the slot die coating, may be equal to or more than 20 m/min. Thus, it is possible to obtain cost-efficiently pre-metered high quality coating layer on a surface of a coating roll by using the slot die coating.

A location of the second coating unit is preferably selected so that a second angle β (shown in FIG. 7b)
that is measured in a travel direction of the coating roll between
   a vertical line formed from a center of the coating roll to an uppermost point of the surface of the coating roll, and
   a second line formed from the center of the coating roll to a second point of a coating roll, the second point defining a point wherein the second coating unit applies the coating on to the coating roll,
      is in a range between 90° and 270°, preferably in a range between 90° and 180°, more preferably in a range between 100° and 170°, and most preferably in a range between 110° and 150°.

Thanks to said second angle β, coating process using the second coating unit may be easier to control than with coating processes having other angles. Further, thanks to the second angle β, particularly if being less than 180°, number of air bubbles in the coating may be decreased. Further, thanks to the location of the second coating unit, it is possible to add several units, such as the first coating unit, the second coating unit, the coating removal unit, and the transferring nip, around the coating roll.

Thanks to the embodiment wherein the slot die coating unit is arranged to apply the coating onto a surface that is going down during the coating process, a coating removal unit can be arranged to remove some of the coating from the same coating roll. Thus, it is possible to have, e.g., two coating units, a coating removal unit, and a transferring nip around one coating roll. This may substantially improve production efficiency of a label machine having such arrangement. Further, due to said structure, shut down time of the label machine may be decreased.

The slot die coating may provide a substantially uniform, continuous coating layer; hence, number of holes may be decreased. Thus, there may not be e.g. any uncoated areas having a surface area of greater than 1.5 cm². Still further, the solubility of the aqueous solution may not be as critical as, e.g., with spraying nozzles. Moreover, the slot die coating does not leave scratches.

### A Coating Roll

A surface of the coating roll may be made of a metal, or it may be made of hard polymer material, or other suitable material. The coating roll has preferably a hard, poreless, high density surface.

The coating roll may have a diameter in a range between 200 mm and 550 mm, preferably in a range between 300 mm and 500 mm. Improved manufacturing method of a label web may be provided thanks to said diameter as well as the hard surface of the coating roll.

Diameter of the coating roll, measured at any time, including during usage of the coating roll, should not vary more than 5 μm, preferably not more than 3 μm, more preferably not more than 2 μm, and most preferably not more than 1.5 μm. Dimensional stability of the coating roll can be very important feature for the coating roll, particularly if a slot die coating unit is used to apply the coating onto the coating roll.

In an advantageous embodiment, the surface of the coating roll is made of chrome. The technical effect of the chrome surface is to obtain an improved wear resistance. Further, surface made of chrome has high density, i.e., it does not have e.g. pores. Still further, coating may be easily transferred from a coating roll having the chrome surface.

A driving speed of (the surface of) the coating roll can be in a range between 20 m/min and 1000 m/min, more preferably in a range between 100 m/min and 800 m/min. Said speed may improve easiness of the coating process. With slot die coating, the driving speed of the coating roll is preferably less than 400 m/min. With curtain coating, the driving speed is preferably at least 250 m/min. If both, the curtain coating and the slot die coating, are used at the same time, the driving speed of the coating roll may be, e.g., between 250 m/min and 400 m/min.

### A Coating Removal Unit

Downstream of the coating unit(s), the arrangement may comprise a coating removal unit for removing part of the coating from the coating roll. The coating removal unit preferably comprises a blade. Thanks to the coating roll, it is possible to use a high pressure level while removing part of the coating. Thus, thanks to the novel solution, the coating-free areas may not comprise a residual amount of the coating.

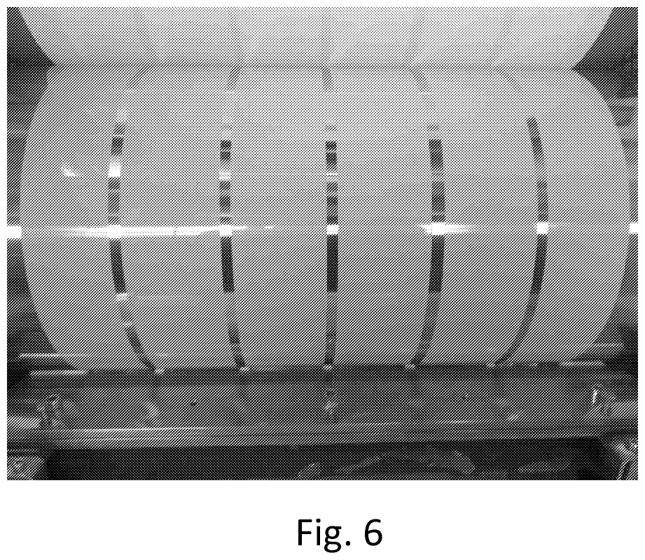

FIG. 6 shows a photo from an experimental test. As can be seen, thanks to the novel solution, part of the coating can be efficiently removed from the coating roll. Furthermore, thanks to the coating roll and the reverse roll, the coatings were efficiently transferred from the coating roll onto a substrate. During the experimental tests, different kind of coatings, including water-based adhesives, were first applied onto the coating roll by using contactless coating method, then part of the coating was removed by using a blade made of PET, and, finally, the remaining coating was successfully transferred onto the substrate.

By using an indirect method without a contacting element, it is possible to apply a thin coating layer on to the substrate, which coating layer can have substantially same thickness through the whole surface of the product. Thus, it is possible to obtain pre-metered, substantially even coating layer. Further, thanks to the coating removal unit, it is possible to remove part of this pre-metered coating layer on the coating roll in order to obtain non coated areas and coated areas, such as coating stripes, having advantages of the pre-metered coating layer.

Conventionally, it has been possible, e.g., to add blocks in a coating unit to obtain e.g. coating stripes. However, locations of the blocks may need to be changed for each manufactured grade, which is typically very time-consuming procedure. A label machine may manufacture several grades in one day. Thus, production efficiency may greatly depend on a shut down time needed for changing locations of the blocks between the grades. Further, the blocks may decrease a quality of the obtained coatings stripes. The novel solution may use a separate coating removal unit instead of the blocks.

Thanks to the novel solution having the non-contact coating unit, and the coating roll, it is possible to remove adhesive from the surface of the coating roll, thus, quality of the coated areas, such as coating stripes, may be improved. Further, production efficiency of a label machine may be significantly improved.

A location of the coating removal unit, such as the blade, is preferably selected so that a third angle λ (shown in FIG. 7c)
that is measured in a travel direction of the coating roll between
   a vertical line formed from a center of a coating roll to an uppermost point of the surface of the coating roll, and
   a third line formed from the center of the coating roll to a third point of a coating roll, the third point defining a point wherein part of a coating is removed from a surface of the coating roll,
      is in a range between 190° and 270°, preferably in a range between 200° and 260°, most preferably in a range between 210° and 250°.

Said third angle may improve efficiency of coating removal. Further, quality of the coated areas may be improved. Further, thanks to said location of the coating removal unit, it is possible to add several units, such as the first coating unit, the second coating unit, the coating removal unit, and the transferring nip, around the single coating roll.

The coating 121 may be applied onto 100% area of a (coating) surface of the coating roll by the first and/or the second coating unit. After that, some of the coating 121 may be removed from the coating roll by using e.g. a blade so as to provide the substrate with alternating coating areas and coating-free areas.

As discussed, part of the coating may be removed from the coating roll by using a coating removal unit comprising blade. The blade is preferably arranged at an angle of 30-50 degrees with respect to the surface of the coating roll. This may improve efficiency of the coating removal from the coating roll, particularly in a case wherein the blade is located so that the third angle λ is more than 180° and less than 270°.

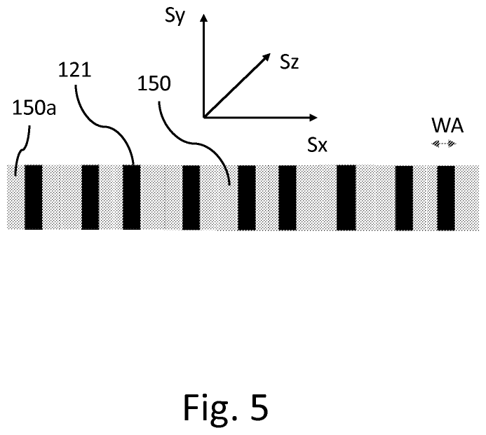

FIG. 5 illustrates a surface having the coating thereon. The surface may be
a surface of the coating roll after part of the coating is removed from the surface of the coating roll, or
a face, or
a carrier material, or
a release liner.

Grey droplets of FIG. 5 illustrate the coating 121 removed from the coating roll by the coating removal unit. Coating removed from the coating roll may be collected and returned back to a first coating unit and/or to a second coating unit. Thanks to the coating roll and the hard surface thereon, the collected coating may not comprise any impurities from the surface wherefrom the coating has been removed.

The blade may comprise or consist of materials selected from the following list:
thermoplastic polymer, preferably polyethylene terephthalate (PET),
carbon fibers, and
a metal, such as a steel.

The carbon fibers may be a quite expensive material for blades. Further, for such a part that needs to be changed often, a manufacturing process of a blade made of carbon fibers might be too challenging, i.e., too expensive.

The steel may also be a quite expensive material for blades. Further, in case of a problem, such as impurities between a blade and a coating roll, steel blades might break the expensive coating roll.

The blade may be made of thermoplastic polymer, preferably thermoplastic polyester, and most preferably polyethylene terephthalate (PET).

The blade may be made of PET, or the blade may be at least mainly made of PET. The PET may be bio-based PET (bio-PET). One technical effect of using PET blade is to provide a light weight blade having suitable stiffness, which may be easily cut e.g. by using a laser. Further, PET blade may be easily changed and cost-efficiently manufactured. Still further, PET blade may be used to protect the coating roll, i.e., in case of a problem, the blade could be broken instead of the expensive coating roll. The blade needs to be changed quite often, hence, easily formed PET blade may be used for avoiding many problems.

Due to the novel solution, wherein the coating is metered onto a surface of the coating roll, part of the coating can be easily removed from the surface of the coating roll. Further, the removal of the coating can be implemented efficiently by using a blade, without causing web breaks or scratches. Further, thanks to the blade and the coating roll, coating removed from the coating roll may not have any impurities, such as fibers from a substrate. Still further, thanks to the blade and the coating roll, the coating may be easily reused in the process. The coating, such as adhesive coating, may be circulated back to a coating unit. Thus, the novel solution may be environmentally friendly method for manufacturing a label web.

In an embodiment, part of the coating is removed from the coating roll by using an oscillating actuator comprising a blade. Thus, the coating removal unit may comprise an oscillating actuator comprising a blade. Therefore, in this embodiment, the blade can be an oscillating blade that removes at least some of the coating. A fast moving mechanical item in very close or contact proximity of a fast moving web might cause e.g. mechanical kind of problems such as vibrations, which could lead to web brakes. However, thanks to hard surface of the coating roll, web brakes can be avoided, even with very high oscillating speed of the blade.

### A Reverse Roll and a Substrate on the Reverse Roll

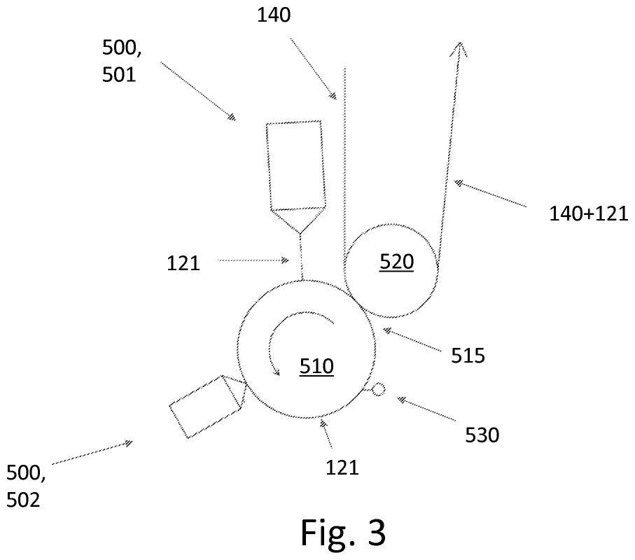

Referring to FIG. 3, the coating 121 may be applied in a contactless manner onto the coating roll 510 and then transferred from the coating roll 510 onto a substrate 140. Said substrate may be a face or a release liner. Alternatively, the substrate may be a carrier material and the coating may be transferred from the carrier material onto a face or a release liner.

The coating 121 may be applied onto a coating roll 510 by using a non-contact coating method, wherein the coating device 500 is not directly touching a surface of the coating roll 510. From the coating roll 510, the coating is applied onto the substrate 140. The substrate 140 can be supported by a reverse roll 520 having, in a nip formed between the coating roll 510 and the reverse roll 520, a direction opposite to a direction of the coating roll. Thanks to the reverse roll and said direction opposite to the direction of the coating roll, the coating may be easily transferred from the coating roll onto the substrate. Without said opposite direction of travel, coating might not be fully transferred from the coating roll onto the substrate, particularly if the substrate had a silicone layer on a surface of the substrate. Thus, without the reverse roll, the coating might simply drop off from the coating roll, without transferring onto the substrate.

The reverse roll 520 has preferably a substantially soft surface in order to improve transferability of the coating. In an embodiment, the reverse roll has an elastic surface, such as rubber, silicon or polyurethane. One suitable commercial material is available from DuPont under tradename Hypalon being chemical, temperature and UV light resistant synthetic rubber. Thanks to said soft surface of the reverse roll and a hard surface of the coating roll, a nip having an improved length may be formed between said rolls.

A driving speed of the reverse roll and the substrate can be in a range between 20 m/min and 1000 m/min, preferably in a range between 100 m/min and 800 m/min. Said speed may improve easiness of the coating process. With slot die coating, the driving speed of the coating roll is preferably less than 400 m/min. With curtain coating, the driving speed is preferably at least 250 m/min. If both, the curtain coating, and the slot die coating are used at the same time, the driving speed of the coating roll may be, e.g., between 250 m/min and 400 m/min.

The driving speed of the reverse roll 520 is preferably substantially same as the driving speed of the coating roll 510. Thus, the driving speed of the substrate is preferably equal to or less than ±10%, more preferably equal to or less than ±6%, and most preferably equal to or less than ±4% from the driving speed of the coating roll. Thus, it is possible to avoid marking on the surface of the coating. Further, it is possible to avoid cutting of the coating, which might be otherwise a problem, particularly if the coating is an adhesive coating.

A pressure in the nip 515 between the reverse 520 roll and the coating roll 510 is preferably in a range between 500 and 1000 N/m. Therefore, it is possible to obtain efficient transfer of the coating from the coating roll onto a substrate. Thus, the coating roll preferably has a surface able to handle such a pressure during the coating process.

### A Nip Between a Coating Roll and a Reverse Roll

As discussed, in order to transfer the coating from the coating roll to a substrate, there is a nip 515 between the coating roll 510 and the reverse roll 520. The coating roll 510 and the reverse roll contra-rotate. At the nip 515, all or substantially all of the coating is transferred from the coating roll on to the substrate. Due to the opposite directions and the nip 515, coating may be transferred efficiently onto the substrate. Thanks to the novel method and the novel arrangement, it is possible to handle coatings, such as adhesives, with wide range of viscosities.

A length of the nip 515 is preferably in a range between 3 mm and 7 mm, more preferably in a range between 4 mm and 6 mm. The nip may be formed between a hard surface of the coating roll and a softer surface of the reverse roll. Thanks to the nip, coating may be transferred efficiently from the coating roll onto the substrate. This may improve controllability of the production and, hence, the production efficiency may be improved.

A location of the nip between the coating roll and the reverse roll is preferably selected so that a fourth angle δ (shown in FIG. 7d)
that is measured in a travel direction of the coating roll between
   a vertical line formed from a center of the coating roll to an uppermost point of the surface of the coating roll, and
   to a fourth line formed from the center of the coating roll to a fourth point of the coating roll, the fourth point defining a point wherein the coating is transferred from the coating roll onto a substrate in the nip,
      is in a range between 270° and 350°, preferably in a range between 280° and 340°, more preferably in a range between 290° and 330°, and most preferably in a range between 300° and 330°.

Thanks to the location of the nip between the coating roll and the reverse roll, it is possible to add several units, such as the first coating unit, the second coating unit, a coating removal unit, and the transferring nip, around the coating roll. Further, the coating may be efficiently transferred from the coating roll onto a substrate.

A pressure of the nip may be in a range between 500 and 1000 N/m. Thus, thanks to said angle and the pressure, coating may be easily transferred from the coating roll onto the substrate.

### Some Examples of Manufacturing Methods

FIGS. 2a-b illustrate some example steps of a method. It is possible that steps 401-406 may take place in various order.

The method may comprise arranging a substrate (step 401), applying coating onto the coating roll (step 402), optionally removing part of the coating (step 403), transferring the coating from the coating roll onto the substrate (step 404), and optionally thermally drying coating (step 405). Steps 402-404 of the method may be performed simultaneously or stepwise.

In an embodiment, coating comprises adhesive stripes, and the adhesive stripes are arranged by applying continuous adhesive layer onto a coating roll in a contactless manner and then removing part of the adhesive coating from the coating roll to form said adhesive stripes.

A method for providing a coating layer on a substrate may comprise the following steps, in accordance with an embodiment:
applying a metered coating onto a coating roll in a contactless manner,
supplying a substrate having a first side and a second side,
transferring the metered coating from the coating roll onto the first side of the substrate,
   thereby obtaining a coating on the substrate.

By using the contactless coating method, it is possible to apply a thin coating layer on to the surface of the first coating layer, which coating layer may be a uniform coating layer having substantially same thickness through the coated areas of the product.

The step of applying the metered coating may comprise the following step:
applying a first curtain of fluid comprising the coating, which first curtain of fluid falls on a surface of a coating roll.

Alternatively, the step of applying the metered coating may comprise the following step:
applying a coating onto a surface of a coating roll by using a slot die coating.

In an embodiment, the coating is applied on the coating roll, transferred onto a face or a release liner, and dried directly on therein in order to obtain label web.

Alternatively, the coating may be first applied on the coating roll, then transferred onto a carrier material, dried on the carrier material, and only then transferred onto the face or the release liner in order to obtain label web.

In these embodiments, the coating is preferably adhesive coating. The benefit of the former method is having less manufacturing steps but on the other hand it may require arrangements not to overheat the substrate, particularly in case of a thermally sensitive material. The benefit of the latter is to be able to perform the drying phase more freely but on the other hand requiring additional processing steps to transfer the dried adhesive onto the face or release liner.

### An Example of a Drying Step

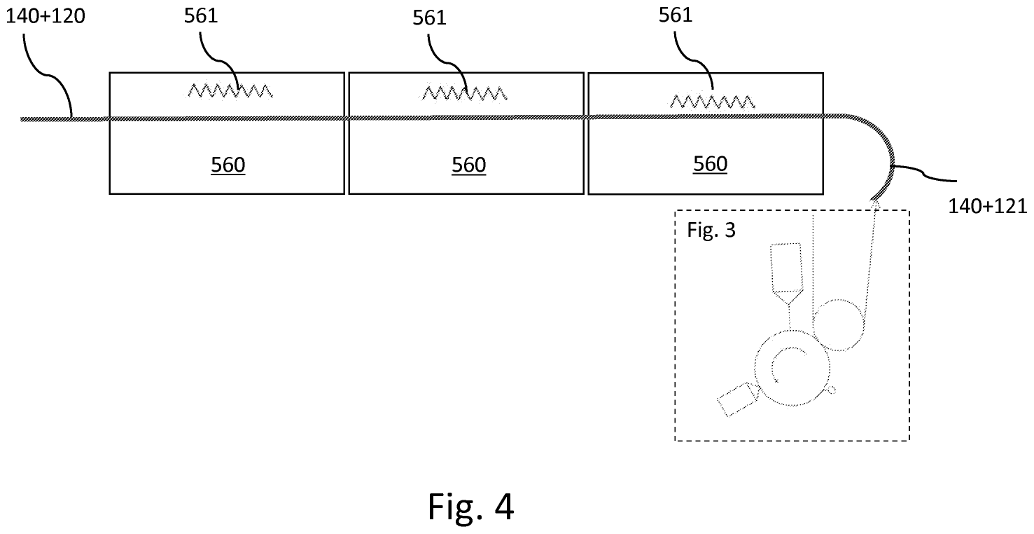

Referring to FIG. 4, the apparatus may comprise at least one drying unit 560 for drying the coating 121. The drying unit 560 comprises at least one drying device 561.

In an embodiment, the coating is transferred on to a substrate, which is a carrier material, and then thermally dried on the carrier material, after which the coating is transferred from the carrier material onto the face or the release liner.

In an embodiment, said coating is first applied on to the face, and then thermally dried into the pressure sensitive adhesive coating on the face.

In an embodiment, said coating is applied on to the carrier material, and then thermally dried on the carrier material.

Thus, the coating may be dried on the face, on the release liner, or on the carrier material. Preferably, the coating is dried on the face 110 or on the release liner 105. This may improve an easiness of the manufacturing process and, further, at least in some cases, improve production efficiency of the manufacturing process.

Drying typically comprises heating. The coating 121 may be dried on one or both sides of the substrate, i.e. above and/or under the substrate. The coating 121 may be dried directly and/or indirectly. Drying may be implemented indirectly by heating the carrier.

Selection of the heating method affects the balance between radiative and convective heat transfer. The coating 121 may be dried by using at least one of the following: infrared energy, microwave energy or air blow. Preferably the coating 121 is dried by air blow or by air blow together with another type of drying. This ensures suitable level of pre-heating of the coating to start the evaporation of the moisture from the coating but preventing, in a case of adhesive coating, the skinning of the adhesive top surface that would block the moisture from escaping out deeper from the adhesive layer.

The drying phase of the label machine comprising the drying unit(s) 560 may have a total length of between 20 and 30 meters. The coating 121 may be dried in at least one drying unit 560.

According to an embodiment, the coating for the label web is dried separately on a carrier material, before attaching the adhesive coating onto a face of the label. This avoids problems arising from heat sensitivity and enables usage of environmentally friendly water-based adhesives in such labels. This approach allows a wider selection of substrate materials for the labels including substrate or coating materials even with lower physical or chemical performance but still fully valid e.g. for on-demand linerless printing and short-lived label applications.

Drying temperature of the coating may be 80-85 degrees C. or even higher. Preferably the drying temperature is at least 75 degrees C. to ensure that the coating becomes fully dried and, if the coating is the adhesive coating, provides maximum adhesive performance such as adhesion.

Water-based adhesive is preferably used in the embodiments of this application. The adhesive is preferably water-based acrylic adhesive for reasons discussed in this specification.

The formed label web 100 comprising a face and a pressure sensitive adhesive coating can be arranged to be rolled onto a label web roll.

### Some Examples of Manufacturing Methods for Label Webs Wherein the Coating Comprises an Adhesive

During a manufacturing process of the label web 100, an adhesive can be dried into a pressure sensitive adhesive coating. Advantageously, the adhesive comprises water-based acrylic adhesive.

The adhesive coating layer may comprise areas with adhesive coating and areas without adhesive coating. The label web may comprise at least one adhesive stripe per each customer roll to be obtained.

In an embodiment, the method may comprise the following step(s):
applying adhesive coating onto a coating roll,
removing at least 10% of the adhesive coating from the coating roll to provide adhesion-free areas.

It should be noted that typically the coating thickness of the adhesive coating as well as the width of the adhesive areas (as well as the adjacent adhesive or adhesion free areas) remain substantially constant over the length of the web. This allows for technically easier implementation of the coating process as well as simplifies curing/drying of the adhesive layer. In the customer rolls, for example, the decreased adhesive coating may improve the functioning of the motorized or manual guillotine in linerless printers. Still further, linerless labels comprising e.g. adhesive stripes might be easier to cut through mechanically in such devices with less adhesive residue left on the cutting blade or edge. Furthermore, it might be easier to achieve good anchorage with water-based acrylic PSA onto the substrate, in some cases even without any additional primer being used.

The previous description illustrates examples and embodiments of a method and an arrangement for manufacturing a label web. Any described examples, embodiments, illustrations, features and/or details thereof may be combined, replaced, or exchanged between their corresponding and/or suitable parts. Obvious structural and/or functional modifications may be made to the previously described examples and embodiments within the scope of the following claims.

1. A method for providing a coating layer for a label web, the method comprising
arranging a substrate,
applying a metered coating in a contactless manner onto a surface of a coating roll (510), and
transferring the coating from the coating roll onto the substrate in a nip thereby forming a coating layer onto the substrate, wherein, in the nip, the surface of the coating roll is running in an opposite direction to a movement of the substrate,
thereby obtaining the coating layer for a label web.

2. The method according to claim 1, wherein at least part of the coating is applied onto the coating roll by using a curtain coating, wherein said at least part of the coating is applied on a first location of the coating roll by using the curtain coating, and the first location is selected so that a first angle α
that is measured in travel direction of the coating roll between
vertical line formed from a center of the coating roll to an uppermost point of the surface of the coating roll, and
a first line formed from the center of the coating roll to a first point of a coating roll, the first point defining a point wherein the curtain coating applies the coating onto the coating roll,
is approximately 0° C. for example in a range between 0° and 10°.

3.-4. (canceled)

5. The method according to claim 2, wherein the curtain coating is a slide coating, and more than one layer is applied by using the curtain coating.

6. The method according to claim 1, further comprising:
removing part, preferably from 10 wt.-% to 90 wt.-%, of the coating from the coating roll in order to form non-coated areas on the coating roll before transferring the coating onto the substrate, wherein a location wherein said part of the coating is removed is selected so that a third angle 1 that is measured in a travel direction of the coating roll between
a vertical line formed from a center of a coating roll to an uppermost point of the surface of the coating roll, and
a third line formed from the center of the coating roll to a third point of a coating roll, the third point defining a point wherein part of a coating is removed from a surface of the coating roll,
is in a range between 190° and 270°.

7. (canceled)

8. The method according to claim 6, wherein said part of the coating is removed from the coating roll by using a blade, wherein the blade is made of polyethylene terephthalate (PET).

9. (canceled)

10. The method according to claim 1, wherein at least part of the coating is applied onto the coating roll by using a slot die coating, wherein at least part of the coating is applied onto the coating roll on a second location of the coating roll by using the slot die coating, and the second location is selected so that a second angle β
that is measured in a travel direction of the roll between
a vertical line formed from a center of the coating roll to an uppermost point of the surface of the coating roll, and
a second line formed from the center of the coating roll to a second point of the coating roll, the second point defining a point wherein the slot die coating applies the coating onto the coating roll,
is in a range between 90° and 270°, preferably in a range between 90° and 180°.

11.-13. (canceled)

14. The method according to claim 1, wherein a location of the nip between the coating roll and the reverse roll is selected so that a fourth angle δ that is measured in a travel direction of the coating roll between
vertical line formed from center of the coating roll to uppermost point of the surface of the coating roll, and
a fourth line formed from the center of the coating roll to a fourth point of the coating roll, the fourth point defining a point wherein the coating is transferred from the coating roll onto a substrate in the nip,
is in a range between 270° and 350°.

15. The method according to claim 1, wherein a length of the nip determined in a travel direction of the coating roll is in a range between 3 mm and 7 mm.

16. The method according to claim 1, wherein a pressure of the nip is in a range between 500 N/m and 1000 N/m.

17. The method according to claim 1, wherein the coating is an adhesive coating.

18. The method according to claim 1, wherein the substrate is a face, or the substrate is a release liner, or the substrate is a carrier material, and the method further comprises:
transferring the coating from the carrier material onto a face or onto a release liner.

19.-20. (canceled)

21. A label web comprising a coating layer obtainable by a method according to claim 1.

22. (canceled)

23. An arrangement for providing a coating layer for a label web, the arrangement comprising
a coating roll arranged to have a travel direction,
at least one coating unit arranged to apply a metered coating in a contactless manner onto the coating roll,
a reverse roll arranged to form a nip between the coating roll and the reverse roll, wherein the coating is arranged to be transferred from the coating roll onto a substrate in the nip, wherein the coating roll is arranged, in the nip, to run in the opposite direction to movement of the substrate and the reverse roll.

24.-25. (canceled)

26. The arrangement according to claim 23, wherein a first location of the coating unit is determined so that the first location has a first angle a in a range between 0° and 10°, which first angle is measured in the travel direction of the coating roll between
a vertical line formed from a center of the coating roll to an uppermost point of the surface of the coating roll, and
a first line formed from the center of the coating roll to a first point of the coating roll, the first point defining a point wherein at least part of the coating is applied onto the coating roll.

27. The arrangement according to claim 23, wherein the at least one coating unit comprises a slot die coating unit.

28. The arrangement according to claim 23, wherein a second location of the coating unit is determined so that the second location has a second angle β in a range between 90° and 270°, preferably in a range between 90° and 180°, which second angle β is measured in the travel direction of the coating roll between
a/the vertical line formed from center of the coating roll to uppermost point of the surface of the coating roll, and
a second line formed from the center of the coating roll to a second point of the coating roll, the second point defining a point wherein at least part of the coating is applied onto the coating roll.

29. The arrangement according to claim 23, further comprising a coating removal unit arranged to remove part, such as from 10 to 90 wt.-%, of the coating from the coating roll in order to form non-coated areas on the coating roll, wherein a location of the coating removal unit is determined so that the location has a third angle λ in a range between 190° and 270°, which third angle λ is measured in the travel direction of the coating roll between
vertical line formed from center of the coating roll to uppermost point of the surface of the coating roll, and
a third line formed from the center of the coating roll to a third point of a coating roll, the third point defining a point wherein part of the coating is removed from the coating roll.

30. (canceled)

31. The arrangement according to claim 29, wherein the coating removal unit comprises a blade, wherein the blade is made of polyethylene terephthalate (PET).

32. (canceled)

33. The arrangement according to claim 23, wherein a location of the nip is determined so that the location has fourth angle δ in a range between 270° and 350°, wherein the fourth angle δ is measured in the travel direction of the coating roll between
vertical line formed from center of the coating roll to uppermost point of the surface of the coating roll, and
a fourth line formed from the center of the coating roll to a fourth point of the coating roll, the fourth point defining a point wherein the coating is arranged to be transferred from the coating roll on to the substrate.

34. The arrangement according to claim 23, wherein a length of the nip, determined in the travel direction of the coating roll, is arranged to be in a range between 3 mm and 7 mm.

35. The arrangement according to claim 23, wherein a pressure of the nip is arranged to be in a range between 500 N/m and 1000 N/m.

36. The arrangement according to claim 23, the arrangement further comprising a means for forming a label web comprising the coating and a face.

37. The arrangement according to claim 23, wherein the coating is an adhesive coating.
